(19) United States
(12) Patent Application Publication
(10) Pub. No.: US 2018/0103104 A1
(43) Pub. Date: Apr. 12, 2018

(54) TRANSITIONING A STATE OF A DISPERSED STORAGE NETWORK

(71) Applicant: International Business Machines Corporation, Armonk, NY (US)

(72) Inventors: Michael Scott Burbey, Thornton, CO (US); S. Christopher Gladwin, Chicago, IL (US); Jason K. Resch, Chicago, IL (US)

(21) Appl. No.: 15/838,983

(22) Filed: Dec. 12, 2017

Related U.S. Application Data
(63) Continuation-in-part of application No. 15/818,633, filed on Nov. 20, 2017.
Application No. 15/818,633 is a continuation-in-part of application No. 14/984,024, filed on Dec. 30, 2015.
(60) Provisional application No. 62/121,736, filed on Feb. 27, 2015.

(51) Int. Cl. H04L 29/08; G06F 3/06; G06F 17/30; G06F 11/16

(52) U.S. Cl. CPC H04L 67/1097; G06F 3/067; G06F 2201/84; G06F 11/1608; G06F 17/30088

(57) ABSTRACT

A method for execution by transition storage facility includes determining to initiate capturing snapshot information from a plurality of modules of a dispersed storage network (DSN). Snapshot scheduling information is issued to a plurality of modules of the DSN. The plurality of modules, in response to receiving the snapshot scheduling information, capture the snapshot information. The snapshot information is received from the plurality of modules, and the snapshot information is stored in temporary storage. A storage operations approach is selected for utilizing the temporarily stored snapshot information, and execution of the storage operations approach is initiated.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/818,633, entitled “UTILIZING MULTIPLE STORAGE POOLS IN A DISPERSED STORAGE NETWORK”, filed Nov. 20, 2017, which is a continuation-in-part of U.S. Utility application Ser. No. 14/984,024, entitled “REBUILDING ENCODED DATA SLICES IN A DISPERSED STORAGE NETWORK”, filed Dec. 30, 2015, which claims priority pursuant to 35 U.S.C. § 119(e) to U.S. Provisional Application No. 62/121,736, entitled “TRANSITIONING A STATE OF A DISPERSED STORAGE NETWORK”, filed Feb. 27, 2015, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a dispersed or distributed storage network (DSN) in accordance with the present invention; and

FIG. 10 is a logic diagram of an example of a method of transitioning a state of a dispersed storage network in accordance with the present invention.

### DETAILED DESCRIPTION OF THE INVENTION

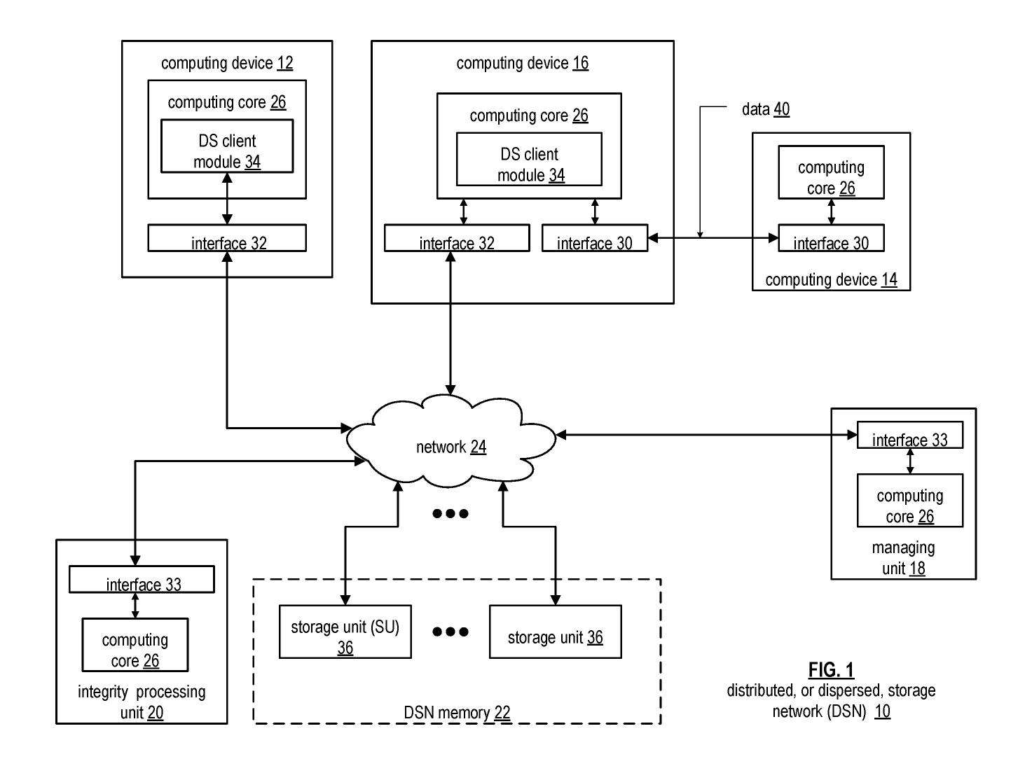

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public interne systems; and/or one or more local area networks (LAN) and/or wide area networks (WAN).

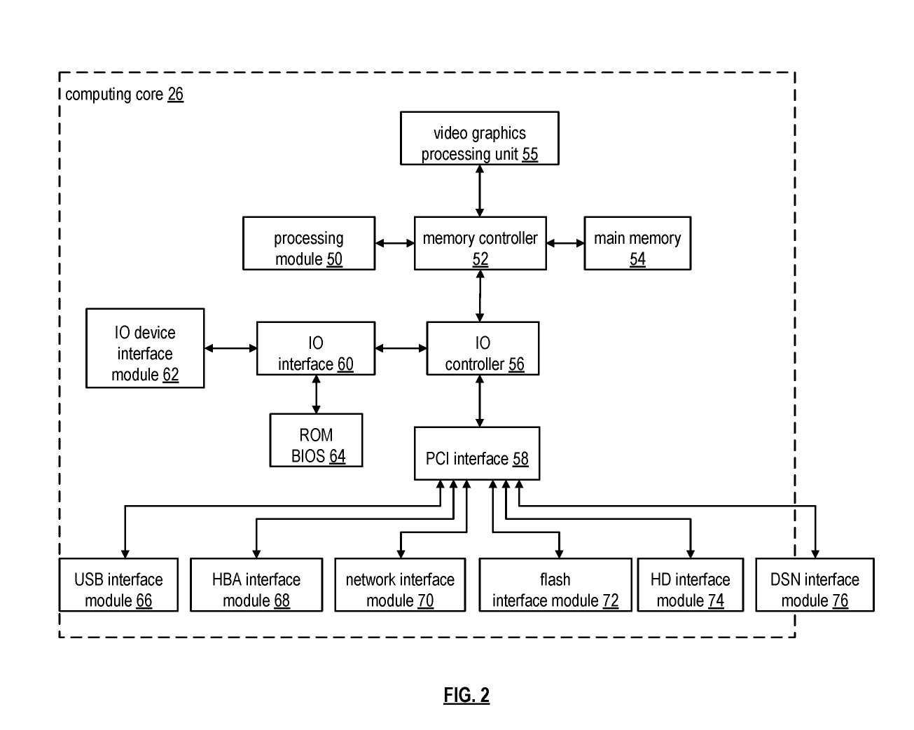

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

In various embodiments, each of the storage units operates as a distributed storage and task (DST) execution unit, and is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc. Hereafter, a storage unit may be interchangeably referred to as a dispersed storage and task (DST) execution unit and a set of storage units may be interchangeably referred to as a set of DST execution units.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each managing unit 18 and the integrity processing unit 20 may be separate computing devices, may be a common computing device, and/or may be integrated into one or more of the computing devices 12-16 and/or into one or more of the storage units 36. In various embodiments, computing devices 12-16 can include user devices and/or can be utilized by a requesting entity generating access requests, which can include requests to read or write data to storage units in the DSN.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. Here, the computing device stores data object 40, which can include a file (e.g., text, video, audio, etc.), or other data arrangement. The dispersed storage error encoding parameters include an encoding function (e.g., information dispersal algorithm (IDA), Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

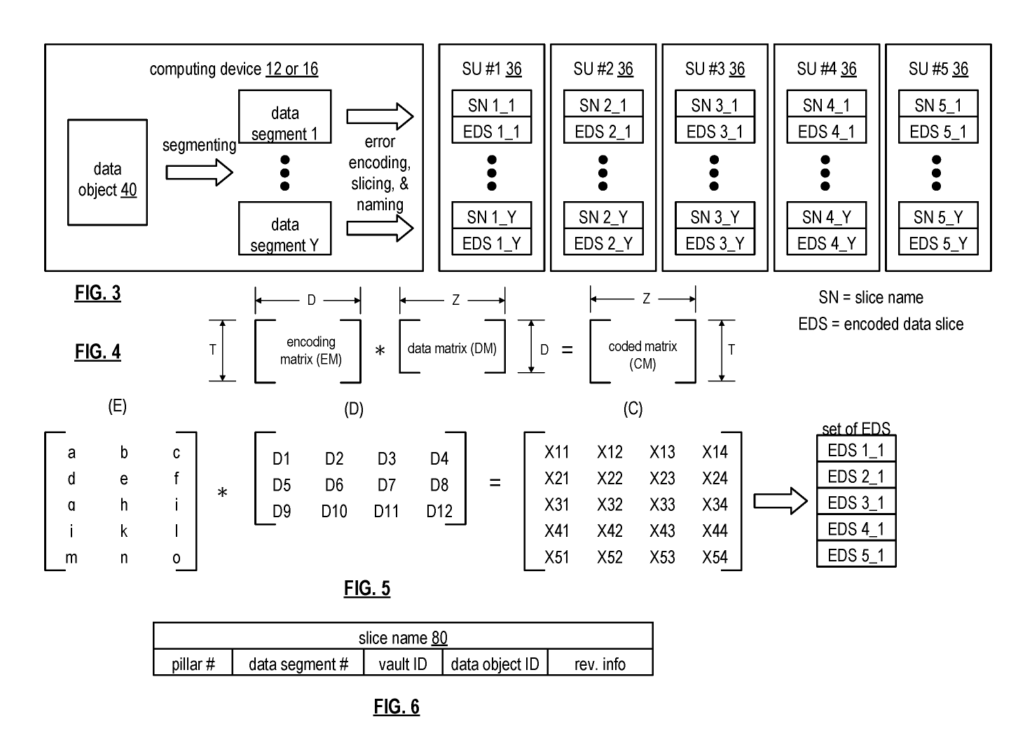

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides data object 40 into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

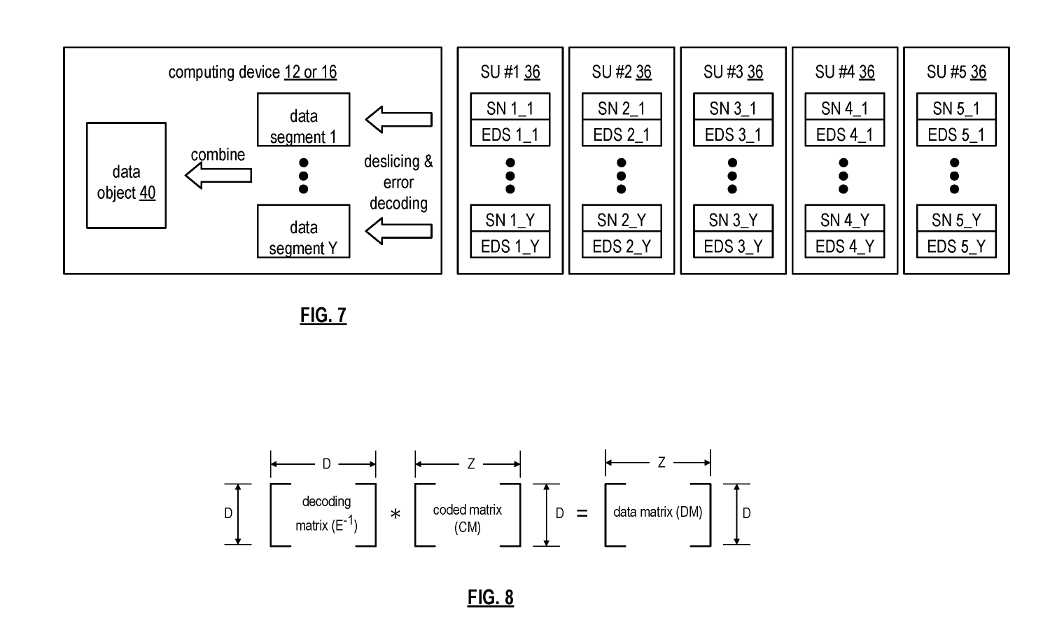

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

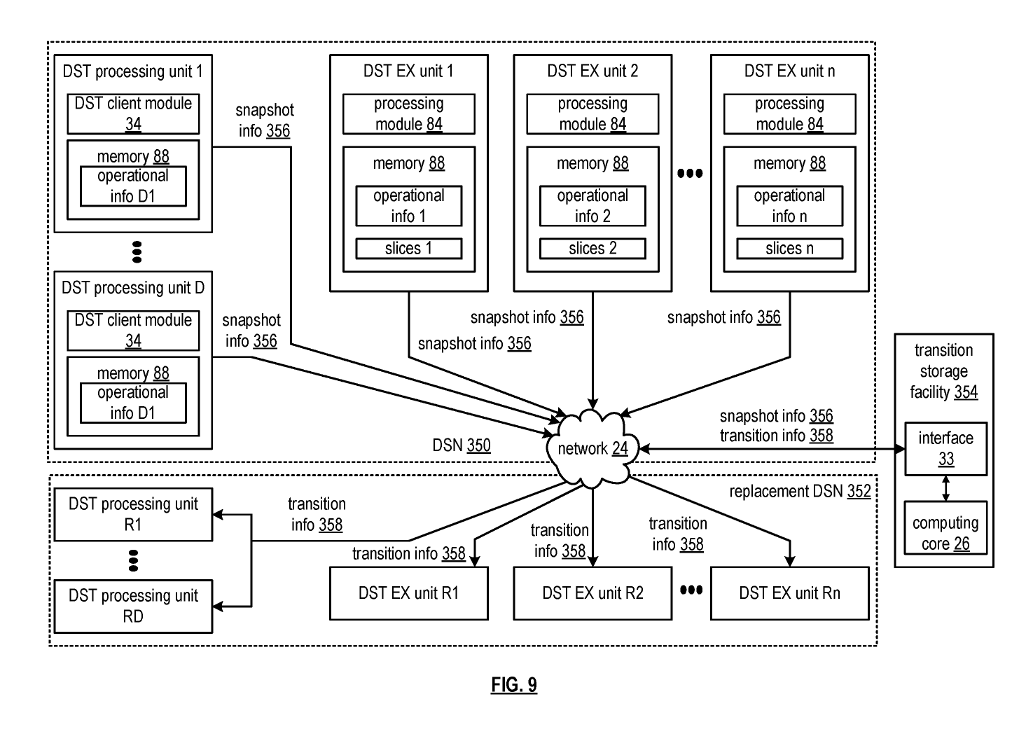

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9 is a schematic block diagram of an embodiment of a dispersed storage network (DSN) 350, a replacement DSN 352, and a transition storage facility 354. The DSN 350 includes a plurality of distributed storage and task (DST) processing units 1-D, at least one set of DST execution (EX) units 1-n, and the network 24 of FIG. 1. The replacement DSN 352 includes a plurality of DST processing units R1 through RD and at least one set of DST execution units R1 through Rn. The transition storage facility 354 includes at least one of an external storage system, a local backup storage system, and/or yet another DSN. The transition storage facility 354 can include at least one processor and memory that stores instructions that configure the processor or processors to perform the functions of the transition storage facility as described herein. For example, as shown in FIG. 9, the transition storage facility can include interface 33 of FIG. 1 and/or the computing core 26 of FIG. 2. Each DST processing unit can be implemented by utilizing the computing device 12 or 16 of FIG. 1, and can include the DS client module 34 of FIG. 1 and a memory 88, which can be implemented by utilizing the main memory 54 of FIG. 2. Each DST execution unit can include a processing module 84 and a memory 88, which can be implemented by utilizing the client module 34 of FIG. 1, the processing module 50 of FIG. 2 and/or the main memory 54 of FIG. 2. The DST execution units can be implemented utilizing the storage units 36 of FIG. 1.

The DSN functions to transition a state of the DSN, which stores data in the set of DST execution units 1-n. The state of the DSN can include one or more of a state of storage of temporary variables associated with processing of storage of data as operational information, a state of storage of encoded data slices, and/or a state of processes utilized to facilitate the storing of the data. A transition of the state can include one or more of completing a process or task associated with the storing of the data, ending usage of the DSN, and/or activating usage of the replacement DSN to continue to fulfill a need of the storing of the data.

A process for capturing the state of an entire DSN Memory (including but not limited to the states of all DST execution units, DST processing units, and/or managing units 18), can begin by pausing the activity of every DST execution unit and/or module, running within each DST execution unit, such as such as client module 34, storage/retrieval modules, rebuilder modules, access modules, and/or other modules. The current state of each module, and/or all memory for each DST execution unit, DST processing unit, and managing unit, can then serialized and persisted. For example, the memory contents of each unit can be serialized over a network interface to a remote storage location, or stored locally to a non-volatile memory device.

This state information for each DST execution unit can be used for several purposes in execution of tasks by the DST execution unit, a DST processing unit, a managing unit, and/or other processing system communicating with network 24. In an example embodiment, the state information can be used at a later time to resume the same DSN memory from its state at the time of capture. As another example, the state information can be used at a later time to reset the state of the DSN memory back to the state of the DSN memory at the time of the state capture. As another example, the state information can be used to form one or more duplicates of the same DSN memory on a new physical instance (different hardware). As another example, the state information can be used to migrate the DSN memory from one set of physical components to another set of physical components.

The process of migration can be performed by the transition storage facility, a DST execution unit, a DST processing unit, a managing unit, and/or other processing system communicating with network 24. The process of migration can begin by first deploying the necessary physical components capable of supporting at least the same number of DST execution units, DST processing units, and/or manager units as were in the DSN memory whose state was captured. The process can then include selecting to which physical components (hardware) each DST execution unit will be deployed to, and the process continues with the transferring of the captured state of those units to be deployed to that hardware destination. The state for those DST execution units can then loaded into memory and “unpaused” (resumed) from where it last left off.

The captured state for any DST execution unit may or may not include slices of that DST execution unit, which can enable a “blank state” (when no slices are included) to be rapidly deployed, or a “complete state” which includes slices, and is source-for-source identical to the previous DSN memory. Due to the inherent redundancy of the slices, a compromise between blank state and complete state may be reached, in which at least a threshold number of DST execution units will be captured with a complete state, while at most width-IDA threshold may be stored as a blank state only. This reduces the size of the state representation of the DSN memory, and via rebuilding processes can ultimately return to the complete state once deployed and resumed.

In an example of operation of the transitioning of the state of the DSN, the transition storage facility 354 (e.g., or any other module associated with the DSN or the replacement DSN) can determine to initiate capturing snapshot information from one or more units and/or modules of the DSN. The determining can include one or more of receiving a request, interpreting a DSN replacement schedule, detecting availability of the replacement DSN, interpreting an error message, detecting that a DSN system health level is less than, or otherwise compares unfavorably to, a minimum health threshold level, and/or receiving a request. Having determined to initiate capturing snapshot information, the transition storage facility 354 can issue snapshot scheduling information to the one or more units and/or modules of the DSN. The issuing can include one or more of updating system registry information, publishing a message, issuing a schedule, issuing error messages, and/or issuing a request.

At least some of the units and/or modules of the DSN receiving the snapshot scheduling information can capture operational information and/or encoded data slices as snapshot information 356. For example, the processing module 84 of the DST execution unit 1 pauses operation of one or more processes, obtains the operational information from the memory 88 of the DST execution unit 1, retrieves encoded data slices from the memory 88 of the DST execution unit 1, generates the snapshot information 356 to include the obtained operational information and retrieved encoded data slices, and/or resumes operations. Having captured the snapshot information 356, the at least some of the units and/or modules of the DSN can send the snapshot information 356 to the transition storage facility 354 for temporary storage.

With the snapshot information 356 stored in the transition storage facility, the transition storage facility 354 can select a storage operations approach that utilizes the temporarily stored snapshot information. The selecting can include one or more of detecting that the replacement DSN 352 is available, interpreting an error message, and receiving a request. The storage operations approach can include restarting state of the DSN at the point of the snapshot, rolling back contents of stored encoded data slices in the DSN to the time of the snapshot, utilizing the replacement DSN as a parallel storage mechanism, and/or decommissioning the DSN after transitioning the state and/or slices to the replacement DSN.

Having selected the storage operation approach, the transition storage facility 354 can initiate the selected storage operations approach. For example, the transition storage facility 354 can send the stored snapshot information 356 to the modules and units of the replacement DSN 352 for initiation of operations as transition information 358 when the DSN 350 is to be decommissioned and replaced by the replacement DSN 352. The modules and/or units of the replacement DSN 352 initiate operation with the operational parameters and/or encoded data slices of the transition information 358.

In various embodiments, a processing system of a transition storage facility includes at least one processor and a memory that stores operational instructions, that when executed by the at least one processor cause the processing system to determine to initiate capturing snapshot information from a plurality of modules of a dispersed storage network (DSN). The plurality of modules can include a dispersed storage and task (DST) execution unit and/or a DST processing unit. Snapshot scheduling information is issued to a plurality of modules of the DSN. The plurality of modules, in response to receiving the snapshot scheduling information, capture the snapshot information. The snapshot information is received from the plurality of modules, and the snapshot information is stored in temporary storage. A storage operations approach is selected for utilizing the temporarily stored snapshot information, and execution of the storage operations approach is initiated.

In various embodiments, determining to initiate capturing snapshot information includes detecting an availability of a replacement DSN. In various embodiments, determining to initiate capturing snapshot information includes determining that a performance level of the DSN compares unfavorably to a performance threshold level.

In various embodiments, the snapshot scheduling information is generated. The snapshot scheduling information includes a pause time frame, and each of the plurality of modules initiate a pause of operations during the pause time frame. In various embodiments, the plurality of modules includes a plurality of DST execution units, and the snapshot information includes encoded data slices stored by the plurality DST execution units. In various embodiments, at least one of the plurality of modules, in response to receiving the snapshot scheduling information, pauses operations of at least one process, obtains operational information in accordance with the snapshot scheduling information, generates the snapshot information based on the operational information, and resumes operations of the at least one process upon completion of generating the snapshot information.

In various embodiments, initiating execution of the storage operations approach includes sending the snapshot information as transition information to a replacement DSN. IN various embodiments, initiating execution of the storage operations approach includes restarting the DSN by sending the snapshot information to the plurality of modules.

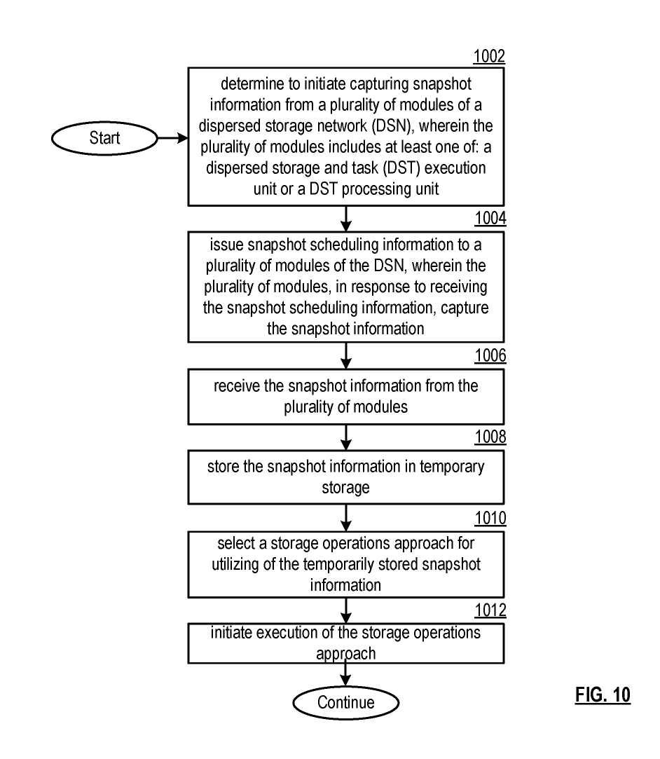

FIG. 10 is a flowchart illustrating an example transitioning a state of a dispersed storage network. In particular, a method is presented for use in association with one or more functions and features described in conjunction with FIGS. 1-9, for execution by a transition storage facility that includes a processor or via another processing system of a dispersed storage network that includes at least one processor and memory that stores instruction that configure the processor or processors to perform the steps described below.

The method includes step 1002, where a processing system (e.g., of a distributed storage and task (DST) client module) determines to initiate capturing snapshot information from a plurality of modules of a dispersed storage network (DSN), where the plurality of modules includes a dispersed storage and task (DST) execution unit or a DST processing unit. The determining can include at least one of receiving a request, interpreting a schedule, detecting availability of a replacement DSN, interpreting an error message, and/or detecting that a performance level of the DSN is less than, or otherwise compares unfavorably to, a minimum performance threshold level.

The method continues at step 1004, where the processing system issues snapshot scheduling information to the one or more modules of the DSN. The issuing includes generating the snapshot scheduling information such that each module shall initiate pausing operations at substantially a same time frame (e.g., allowing for time to propagate information), and sending the snapshot scheduling information to the one or more modules. The issuing further includes one or more of the processing system updating system registry information, publishing a message, issuing a schedule, issuing error messages, and issuing a request. The plurality of modules, in response to receiving the snapshot scheduling information, capture the snapshot information. Each module receiving the snapshot scheduling information can capture operational information and/or encoded data slices as the snapshot information. For example, some or all modules that receive the snapshot scheduling information can pause operations of one or more processes associated with the module, obtain the operational information and/or encoded data slices in accordance with the snapshot scheduling information, generate the snapshot information, and/or can resume operations in accordance with the snapshot scheduling information, for example, upon completion of generating the snapshot information.

Each module capturing the snapshot information can send the snapshot information to the transition storage facility for temporary storage. For example, each module identifies the transition storage facility (e.g., in accordance with the snapshot scheduling information, by interpreting a query response, in accordance with a predetermination, based on identifying a replacement DSN), and outputs the snapshot information to the identified transition storage facility.

The method continues at step 1006, where the processing system receives snapshot information from the plurality of modules. The method continues at step 1008, where the processing system stores the snapshot information in temporary storage. The method continues at step 1010 where the processing system selects a storage operations approach for utilizing of the temporarily stored snapshot information. The selecting can include at least one of detecting that the replacement DSN is available, interpreting an error message, and/or receiving a request. The method continues at step 1012, where the processing system initiates execution of the storage operations approach. For example, the processing system sends the snapshot information as transition information to the replacement DSN when activating the replacement DSN. As another example, the processing system sends the snapshot information to modules of the DSN when restarting the DSN in accordance with a previous snapshot.

In various embodiments, a non-transitory computer readable storage medium includes at least one memory section that stores operational instructions that, when executed by a processing system of a dispersed storage network (DSN) that includes a processor and a memory, causes the processing system to determine to initiate capturing snapshot information from a plurality of modules of a dispersed storage network (DSN). The plurality of modules can include a dispersed storage and task (DST) execution unit and/or a DST processing unit. Snapshot scheduling information is issued to a plurality of modules of the DSN. The plurality of modules, in response to receiving the snapshot scheduling information, capture the snapshot information. The snapshot information is received from the plurality of modules, and the snapshot information is stored in temporary storage. A storage operations approach is selected for utilizing the temporarily stored snapshot information, and execution of the storage operations approach is initiated.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing system”, “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a transition storage facility that includes a processor, the method comprises:
determining to initiate capturing snapshot information from a plurality of modules of a dispersed storage network (DSN), wherein the plurality of modules includes at least one of: a dispersed storage and task (DST) execution unit or a DST processing unit;
issuing snapshot scheduling information to a plurality of modules of the DSN, wherein the plurality of modules, in response to receiving the snapshot scheduling information, capture the snapshot information;
receiving the snapshot information from the plurality of modules;
storing the snapshot information in temporary storage;
selecting a storage operations approach for utilizing the temporarily stored snapshot information; and
initiating execution of the storage operations approach.

2. The method of claim 1, wherein determining to initiate capturing snapshot information includes detecting an availability of a replacement DSN.

3. The method of claim 1, wherein determining to initiate capturing snapshot information includes determining that a performance level of the DSN compares unfavorably to a performance threshold level.

4. The method of claim 1, further comprising:
generating the snapshot scheduling information;
wherein the snapshot scheduling information includes a pause time frame, and wherein each of the plurality of modules initiate a pause of operations during the pause time frame.

5. The method of claim 1, wherein plurality of modules includes a plurality of DST execution units, and wherein the snapshot information includes encoded data slices stored by the plurality DST execution units.

6. The method of claim 1, wherein at least one of the plurality of modules, in response to receiving the snapshot scheduling information:
pauses operations of at least one process;
obtains operational information in accordance with the snapshot scheduling information;
generates the snapshot information based on the operational information; and
resumes operations of the at least one process upon completion of generating the snapshot information.

7. The method of claim 1, wherein initiating execution of the storage operations approach includes sending the snapshot information as transition information to a replacement DSN.

8. The method of claim 1, wherein initiating execution of the storage operations approach includes restarting the DSN by sending the snapshot information to the plurality of modules.

9. A processing system of a transition storage facility comprises:
at least one processor;
a memory that stores operational instructions, that when executed by the at least one processor cause the processing system to:
determine to initiate capturing snapshot information from a plurality of modules of a dispersed storage network (DSN), wherein the plurality of modules includes at least one of: a dispersed storage and task (DST) execution unit or a DST processing unit;
issue snapshot scheduling information to a plurality of modules of the DSN, wherein the plurality of modules, in response to receiving the snapshot scheduling information, capture the snapshot information;
receive the snapshot information from the plurality of modules;
store the snapshot information in temporary storage;
selecting a storage operations approach for utilizing the temporarily stored snapshot information; and
initiate execution of the storage operations approach.

10. The processing system of claim 9, wherein determining to initiate capturing snapshot information includes detecting an availability of a replacement DSN.

11. The processing system of claim 9, wherein determining to initiate capturing snapshot information includes determining that a performance level of the DSN compares unfavorably to a performance threshold level.

12. The processing system of claim 9, wherein the operational instructions, when executed by the at least one processor, further cause the processing system to:
generate the snapshot scheduling information;
wherein the snapshot scheduling information includes a pause time frame, and wherein each of the plurality of modules initiate a pause of operations during the pause time frame.

13. The processing system of claim 9, wherein plurality of modules includes a plurality of DST execution units, and wherein the snapshot information includes encoded data slices stored by the plurality DST execution units.

14. The processing system of claim 9, wherein at least one of the plurality of modules, in response to receiving the snapshot scheduling information:
pauses operations of at least one process;
obtains operational information in accordance with the snapshot scheduling information;
generates the snapshot information based on the operational information; and
resumes operations of the at least one process upon completion of generating the snapshot information.

15. The processing system of claim 9, wherein initiating execution of the storage operations approach includes sending the snapshot information as transition information to a replacement DSN.

16. The processing system of claim 9, wherein initiating execution of the storage operations approach includes restarting the DSN by sending the snapshot information to the plurality of modules.

17. A computer readable storage medium comprises:
at least one memory section that stores operational instructions that, when executed by a processing system of a dispersed storage network (DSN) that includes a processor and a memory, causes the processing system to:
determine to initiate capturing snapshot information from a plurality of modules of the DSN, wherein the plurality of modules includes at least one of: a dispersed storage and task (DST) execution unit or a DST processing unit;
issue snapshot scheduling information to a plurality of modules of the DSN, wherein the plurality of modules, in response to receiving the snapshot scheduling information, capture the snapshot information;
receive the snapshot information from the plurality of modules;
store the snapshot information in temporary storage;
select a storage operations approach for utilizing the temporarily stored snapshot information; and
initiate execution of the storage operations approach.

18. The computer readable storage medium of claim 17, wherein determining to initiate capturing snapshot information includes detecting an availability of a replacement DSN.

19. The computer readable storage medium of claim 17, wherein determining to initiate capturing snapshot information includes determining that a performance level of the DSN compares unfavorably to a performance threshold level.

20. The computer readable storage medium of claim 17, wherein the operational instructions, when executed by the processing system, further cause the processing system to:
generate the snapshot scheduling information;
wherein the snapshot scheduling information includes a pause time frame, and wherein each of the plurality of modules initiate a pause of operations during the pause time frame.
